(19) United States
(12) Patent Application Publication
(10) Pub. No.: US 2010/0282325 A1
(43) Pub. Date: Nov. 11, 2010

(54) Gas Flow Control System

(75) Inventor: Ottavio Cimino, Revesby (AU)

Correspondence Address: FENWICK & WEST LLP, SILICON VALLEY CENTER, 801 CALIFORNIA STREET, MOUNTAIN VIEW, CA, 94041, US

(73) Assignee: CLARA APPLIANCES PTY LTD, Wetherill Park (AU)

(21) Appl. No.: 12/670,357

(22) PCT Filed: Jul. 23, 2008
(86) PCT No.: PCT/AU08/01065

§ 371 Date: Jul. 30, 2010

(30) Foreign Application Priority Data
Jul. 23, 2007 (AU) 2007903964

(51) Int. Cl. F17D 1/00; F16K 31/02

(52) U.S. Cl. 137/1; 251/129.2

(57) ABSTRACT

A gas flow control system is arranged for regulating the gas supply to a burner comprising a safety valve. The safety valve is arranged to open and close a gas supply opening. The gas flow control system is driven by a motor and comprises driving means configured for engaging an end of a safety valve spindle, for moving the safety valve spindle from a closed to an open configuration. The driving means comprise converter means disposed intermediate the motor and an end of a push pin. The converter means are configured to convert the rotational movement of a drive shaft, rotated by the motor, into a linear movement of the push pin. The pin is engageable with the end of the safety valve spindle and is movable to push the safety valve spindle from the closed to the open configuration.

### FIELD OF THE INVENTION

The present invention generally relates to gas flow control and, in particular, to a system for controlling the flow of gas supplied to gas burners, such as those used in cooking appliances and monitoring/maintaining flame safety in the burners. The present invention also relates to a method and apparatus for controlling the flow of gas in such gas burning appliances.

### BACKGROUND

Most conventional gas cooking appliances utilise a manually operated gas regulating valve which incorporates a gas flame safety control system. The gas flame safety control system comprises a bi-metal thermocouple connected to an electromagnetic valve. An example of such an electromagnetic valve 100 is shown in FIG. 1. The electromagnetic valve 100 comprises an electromagnetic coil 101 and a spring loaded valve 102. The spring loaded valve 102 includes a safety valve spindle 103 having a neoprene seal 104 at one end, and a metal plate 105 at the other end. The electromagnetic coil 101 of the electromagnetic valve 100 is usually connected to a bi-metal thermocouple, not shown, which generates an electric current, when in contact with a heat source. When the electromagnetic coil 101 is powered up, the coil 101 generates a magnetic field. The associated magnetic force attracts the metal plate 105 and holds the metal plate 105, thereby locking the valve 100 in its closed configuration.

However, the magnetic force generated by the electromagnetic coil 101 is efficient only at close range of up to about one millimetre and is not sufficiently strong to breach the gap between the coil 101 and plate 105, when the valve 100 is in a fully open configuration as shown in FIG. 1. To address this issue, some conventional devices provide manual means for pushing the valve 100 into its closed configuration. The closed configuration is then maintained by the powered electromagnetic coil 101. One such solution is illustrated in FIG. 2, where a press-button 206 is manually depressed to push forward a pin 207. The pin 207 pushes forward a spindle 203. Once a metal plate 205 is moved within operational range of the electromagnetic coil 201, the coil 201 attracts metal plate 205 to and the valve 200 is locked into its open configuration.

During this manually performed gas ignition operation, an operator actually needs to simultaneously perform several functions. Firstly the press-button 206 is pushed in. This action actually involves three discrete operations; a locking notch, not shown, on the spindle is disengaged, the safety valve 200 is pushed open to allow gas flow and, if the gas tap incorporates electronic ignition control switches, the ignition system is activated. Secondly the press-button 206 is turned to open the tap and allow free gas flow. Finally, the operator has to keep the press-button 206 depressed until such time as the thermocouple, not shown, establishes a stable power supply to the electromagnetic coil. Generally, this requires approximately 2 to 8 seconds.

It is clear from the above description that such a manual operation of the gas-burning device is generally inconvenient and requires operational skills and knowledge from the user. In addition, the various buttons, mechanical dials, knobs and switches are often unsealed. The ingress of cooking or other fluids, dust, dirt and moisture destroys the aesthetic appeal of the cooking appliance and causes operational breakdowns.

Also, many existing manual gas control systems used in cooking appliances are not compatible with standard electronic control interfaces. Furthermore, many conventional gas control systems rely entirely on the mains power supply for both their initial start-up routine and their continuous operation.

Accordingly, it is desirable to develop a more convenient and self-reliable gas flow control system for such gas appliances.

### SUMMARY

It is an object of the present invention to substantially overcome, or at least ameliorate, one or more disadvantages of existing systems.

According to one aspect of the invention, there is provided a gas flow control system for regulating the gas supply to a burner, the system being driven by a drive shaft rotatable by a motor, the system comprising;
a safety valve arranged to open and close a gas supply opening, the safety valve comprising;
   a safety valve spindle movable between an open and a closed configuration of the safety valve, the safety valve spindle being biased into the closed configuration, a first end of the safety valve spindle comprising a locking metal plate and a second end of the safety valve spindle comprising a sealing member arranged to seal the gas supply opening in the closed configuration; and
   an electromagnetic coil configured, when the electromagnetic coil is powered up and when the locking metal plate is presented within an operational range of the coil, to attract the locking plate and lock the safety valve spindle in the open configuration; and
driving means configured for engaging the second end of the safety valve spindle for moving the safety valve spindle from the closed to the open configuration, the driving means comprising;
   a push pin disposed so that a first end of the push pin is engageable with the second end of the safety valve spindle, the pin being movable to push the safety valve spindle from the closed to the open configuration; and
   converter means disposed intermediate the drive shaft and the second end of the push pin, the converter means being configured to facilitate the conversion of the rotational movement of the drive shaft into a linear movement of the push pin.

Preferably, the system further comprises a gas flow regulating valve, the gas flowing through the safety valve being directed to further flow through the gas flow regulating valve, the arrangement being such that that rotation of the gas flow regulating valve in a first predetermined direction increases, while a rotation of the gas flow regulating valve in a second direction, opposite to the first predetermined direction, decreases the amount of gas supplied to the burner.

Even more preferably, the converter means comprise a first cam formation secured to a housing accommodating at least a portion of the driving means, the driving means further comprise;
a cam spindle engageable with the second end of the push pin and with the flow regulating valve, the cam spindle comprising a second cam formation and being configured such that, upon rotation of the cam spindle, the second cam formation engages the first cam formation so that the rotating cam spindle rotates the gas flow regulating valve and slides, within the gas flow regulating valve, to effect the linear movement of the push pin;
a driving spindle engaged with the cam spindle so as to rotate the cam spindle; and
a reduction gear assembly connected intermediate the driving shaft and the driving spindle so as to rotate the driving spindle with a reduced rotational speed with respect to that of the driving shaft.

According to a second aspect of the invention, there is provided method of controlling the amount of gas provided to a gas burner, by using the gas flow control system of the first aspect, the method comprising the following steps;
when a start touch button is pressed by a user, a first trigger signal is sent to the processor;
upon receiving the first trigger signal, the processor supplies power to the electromagnetic coil by connecting the electromagnetic coil to both the thermocouple and the battery, the powered electromagnetic coil locking the safety valve spindle in the open configuration;
driving signal is sent from the processor to the motor for rotating the cam spindle in the predetermined first direction, the rotation of the cam spindle in the first direction initially releasing the pressure on the push pin and then opening the gas flow regulating valve to provide gas to the burner;
the processor drives the electronic ignition module to generate spark for igniting the gas;
upon a release of the touch button by the user, a second trigger signal is sent to the processor,
depending on the length of time between the first and the second trigger signals, the processor continues to drive the cam spindle until the gas flow regulating valve reaches either a predetermined rotational position, the predetermined rotational position defining the gas flow through the gas flow regulating valve; and
a predetermined time after the first or the second trigger signal, or when the processor detects adequate electrical supply from the thermocouple, the processor disengages the electronic ignition module and the power supply from the battery to the electromagnetic coil.

Preferably, for discontinuing the gas supply to the burner, the method of the second aspect further comprises the steps of;
a stop touch button pressed by the user sends a third trigger signal to the processor; and
upon receiving the third trigger signal, the processor sends driving signals to the motor to rotate the gas flow regulating valve in the second direction to close the gas flow regulating valve, and push the push pin to move and maintain the safety valve spindle into a fully open configuration.

### BRIEF DESCRIPTION OF THE DRAWINGS

Some aspects of the prior art and one or more embodiments of the present invention will now be described with reference to the drawings and appendices, in which:

FIG. 1 shows a perspective view of an electromagnetic gas safety valve;

FIG. 2 shows a cross-sectional view of a prior art gas flow control system using the electromagnetic gas safety valve of FIG. 1;

FIG. 3 shows a cross-sectional view of a gas flow control system according to one embodiment;

FIGS. 4 to 6 show perspective views of two configurations of a reduction gear assembly of the gas flow control system of FIG. 3;

FIG. 7 shows a perspective view of a driving engagement between a driving spindle, a cam spindle and a gas regulating valve of the gas flow control system of FIG. 3;

FIGS. 8 and 9 show a cross-sectional view of the gas flow control system of FIG. 3, in which a cam spindle is in a fully pushed and a fully retracted configuration, respectively; and

FIG. 10 is a schematic electronic diagram of a control circuit of the gas flow control system of FIG. 3.

### DETAILED DESCRIPTION INCLUDING BEST MODE

Reference numerals that have different first digits but identical remaining digits, refer to the same or equivalent structural elements, function(s) or operation(s), unless the contrary intention appears.

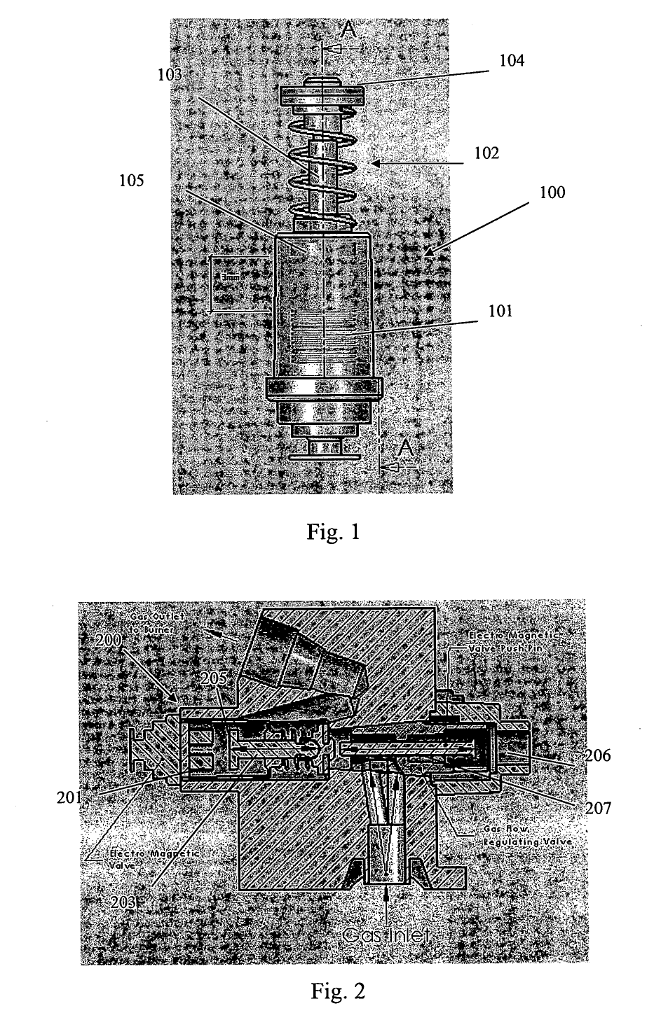

FIGS. 1 and 2 have already been described in the “Background” section of this specification in relation to relevant prior art systems. It is to be noted that any discussions of prior art systems contained in the “Background” section or in this description relate to documents or devices which may form public knowledge through their respective publication and/or use. However, such discussions should not be interpreted as an admission by the present inventor(s) or patent applicant that such documents or devices in any way form part of the common general knowledge in the art.

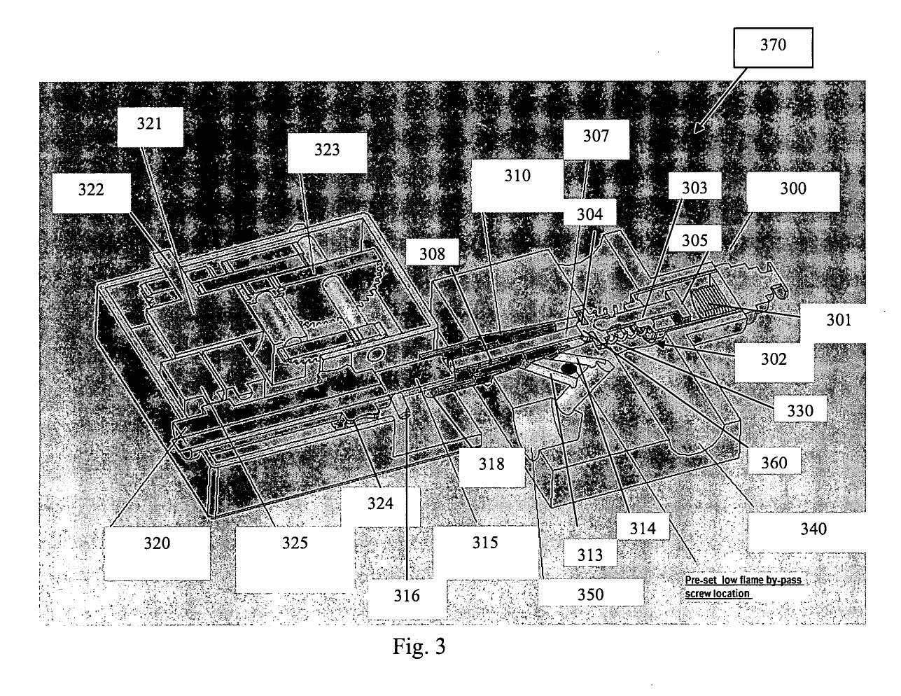

The proposed gas flow control system 370 for regulating a gas supply to a burner is shown in FIG. 3. The system 370 comprises an electromagnetic safety valve 300, which is substantially identical to the electromagnetic valve 100 from FIG. 1. The electromagnetic valve 300 comprises an electromagnetic coil 301 and a spring loaded valve 302, comprising a safety valve spindle 303. The safety valve spindle 303 includes a sealing member, in the form of a sealing membrane 304, at one end, and a metal plate 305, at the other end.

Gas enters the system 370 via a gas inlet 340. If no power is supplied to the electromagnetic coil 301, a coil spring 330 biases the spindle 303 away from the electromagnetic coil 301 and into a closed configuration of the safety valve 300. In this closed configuration, a sealing membrane 304 seals opening 360 and prevents gas from propagating further in the system 370.

The gas flow control system 370 further comprises a gas flow regulating valve 310, a movable push pin 307, axially disposed within the gas flow regulating valve 310, a cam spindle 315 and a driving spindle 320. A return compression spring 308 biases the push pin 307 into a retracted position away from the electromagnetic coil 301. As shown in FIG. 3 and FIG. 7, the electromagnetic safety valve 300, the gas flow regulating valve 310, push pin 307, the cam spindle 315 and the driving spindle 320 are substantially axially aligned.

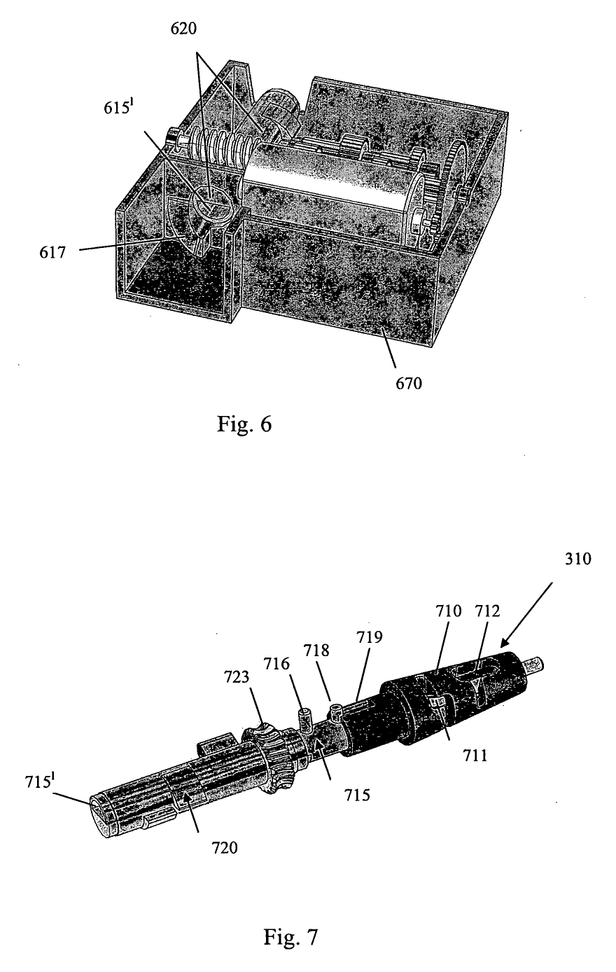

The spindle 303 is arranged to engage with the push pin 307, which is engageable with the cam spindle 315. The arrangement is such that when the push pin 307 is pushed in the direction of the electromagnetic coil 301 by the cam spindle 315, push pin 307 engages spindle 303 and moves it away from the fully closed configuration. The driving spindle 320 and at least a portion of the cam spindle 315 are designed to have complementary shapes. This is illustrated in FIG. 6 and FIG. 7 which show driving spindle 620 (720) and slot 615¹ (715¹) that accommodates a portion of the cam spindle 715. Because of the complimentary shapes of the two spindles, rotation of the driving spindle 320 rotates the cam spindle 315.

With reference to FIG. 3, the cam spindle 315 comprises a cam pin 316 arranged to be engage with a cam formation 617, secured externally to cam spindle 315. As shown in FIG. 6, the cam formation 617 may, for example, be secured to housing 670 that accommodates either a portion or the entire length of driving spindle 620 and cam spindle 315. The cam formation 617 has a camming profile arranged so that, as a result of the engagement between cam pin 316 and a cam formation 617, rotation of the cam spindle 315 effects a linear movement of the cam spindle 315 within the gas flow regulating valve 310. As it would be described later, the rotation of cam spindle 315 is caused by a drive shaft 322 which is rotatably driven by a motor 321. Thus, the arrangement involving the cam pin 316 and the cam formation 617 serves as converter means that effectively facilitates the conversion of the rotational movement of the drive shaft 322 into a linear movement of the push pin 307. The linear movement of the cam spindle 315 is guided by a sliding pin 318, best shown in FIG. 7 under reference numeral 718. The pin 718 is slidingly engaged with a sliding groove 719 of the gas flow regulating valve 310. The engagement between the pin 718 and the sliding groove 719 ensures that a rotation of the cam spindle 315(715) drivingly rotates the gas flow regulating valve 310.

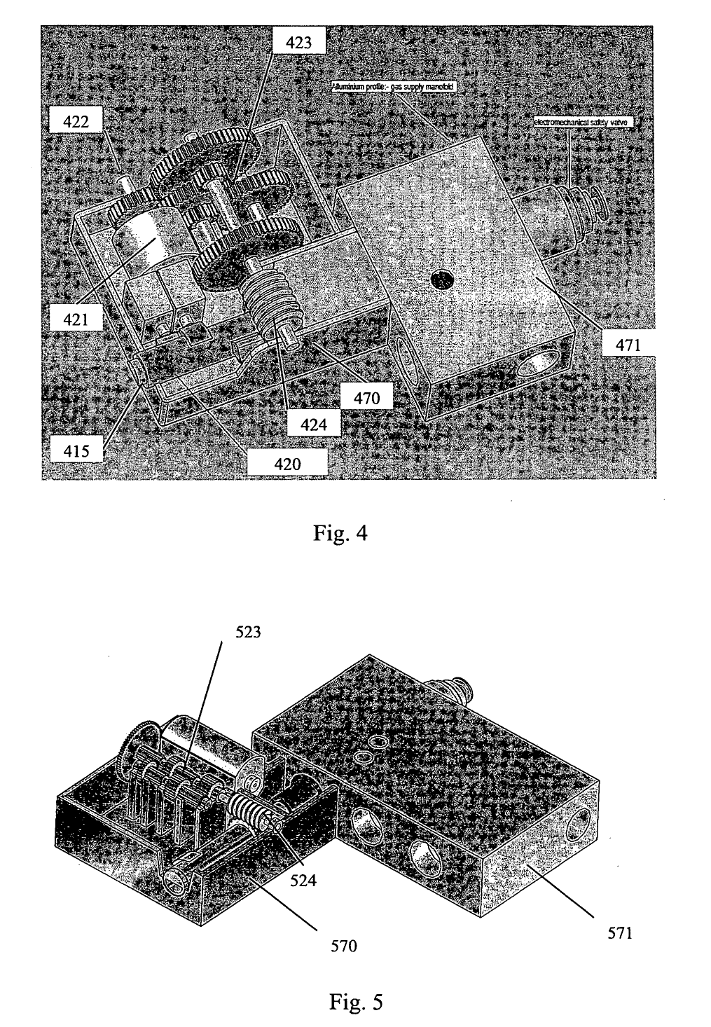

The entire gas flow control system 370 is driven by the DC motor 321. The drive shaft 322 of the DC motor 321 effects the rotation of the driving spindle 320. A reduction gear assembly 323, connected intermediate drive shaft 322 and driving spindle 320, reduces the rotational speed of the driving spindle 320 with respect to the rotational speed of the drive shaft 322. A threaded formation 324 transfers the rotation with respect to the axis of the reduction gear assembly 323 to a rotation with respect to the substantially transverse axis of the driving spindle 320. The threaded formation 324 is best shown in FIGS. 4 and 5. FIG. 4 also illustrates the complimentary engagement between the driving spindle 420 and the cam spindle 415.

The gas flow regulating valve 310 comprises openings, labelled with numerals 711 and 712 in FIG. 7, which are aligned with respective gas outlet openings 313 and 314, as shown in FIG. 3. Rotation of the gas flow regulating valve 310 in a clockwise direction reduces the offset between the valve openings 711 and 712, and the outlet openings 313 and 314, thus increasing the amount of gas flowing through gas outlet 350. A rotation of the gas flow regulating valve 310 in an anti-clockwise direction increases the offset between the respective openings to reduce the gas flow output through the gas outlets 350.

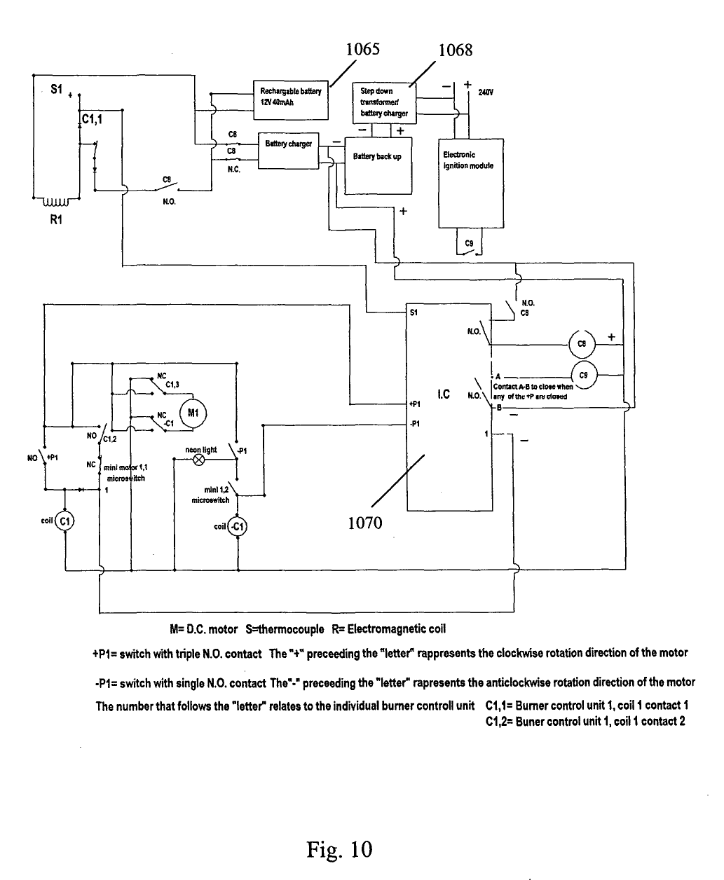

When the system 370 is operational and gas is supplied to the gas burner, not shown, the electromagnetic safety valve 300 is maintained in the open configuration by the electromagnetic coil 301. Power is provided to the electromagnetic coil 301 from a thermocouple S1, shown in FIG. 10. The thermocouple S1 generates the required current only when the thermocouple S1 is heated up. To ensure that the thermocouple S1 is continuously heated during the operation of the system 370, the thermocouple S1 is disposed within the burning gas. This facilitates the safety functionality of the safety valve since, if for any reason the burning process is interrupted, the thermocouple S1 cools down and discontinues the power supply to the electromagnetic coil 301. This interruption of power supply to the electromagnetic coil 301 releases the safety valve spindle 303. As discussed earlier, the safety valve spindle 303 is biased, by spring 330, into the closed configuration of the safety valve 300. Accordingly, once released by the electromagnetic coil 301, the safety valve spindle 303 moves to seal the opening 360 and discontinue any further gas supply to the burner.

As was mentioned in the background section, one problem with such an arrangement relates to the fact that thermocouples usually require at least several seconds of warm-up time. This issue is addressed in the embodiment shown in FIG. 3 by providing an alternative power supply to the electromagnetic coil 301 during warm-up time of the thermocouple S1. Thus, the thermocouple S1 is only partially responsible for powering up the electromagnetic coil 301, since the alternative power supply is connected in parallel to the thermocouple S1 and provides independently power, at least on temporal basis, to the electromagnetic coil 301. In the embodiment shown in FIG. 10, a chargeable battery 1065 is used as such an alternative power supply. This alternative power supply also ensures that the gas flow control system 370 can commence operation without the mains power supply. Furthermore, there is an additional battery back-up power supply 1068, which allows the gas flow regulating system 370 to continue safe operation in case of an extended period of mains power supply failure. Here it has to be noted that the overall power supplied by any of the power sources should not exceed the safety limits of the electromagnetic coil 301. If those limits are exceeded, the electromagnetic coil can overheat in the combustible gas filled manifold, thus causing a potential hazard.

In one embodiment, the alternative battery 1065 is rated: 12 Volts; ≦40 mAh. The alternative battery current rating should preferably be not much higher than 40 mAh, since using a battery with a higher current rating can, over a short period of time, cause the electromagnetic coil 301 to overheat. The electromagnetic coil 301 is located inside a gas supply manifold 471 (FIG. 4). Accordingly, in direct contact with flammable gas, overheating of the electromagnet coil 301 can pose a safety problem. This problem is minimised by using the suggested current rating. A further safety improvement is indicated in the electronic circuitry of the proposed gas flow control system 370, shown in FIG. 10. The circuitry is designed so that, when the electromagnetic coil 301 is powered by the alternative battery 1065, the power supply from the battery 1065 is completely isolated from the recharging system, now shown, and any other power sources. This ensures that, when in use, the battery 1065 is the only source supplying power to the electromagnetic coil 301. As discussed earlier in the text, in case when the electric power to the electromagnetic coil is supplied by other electronic circuitries, it has to made sure that under any abnormal or normal operation, the current supplied to the electromagnetic coil 301 does not exceeds 40 mAh at 12V D.C. for the reasons detailed above.

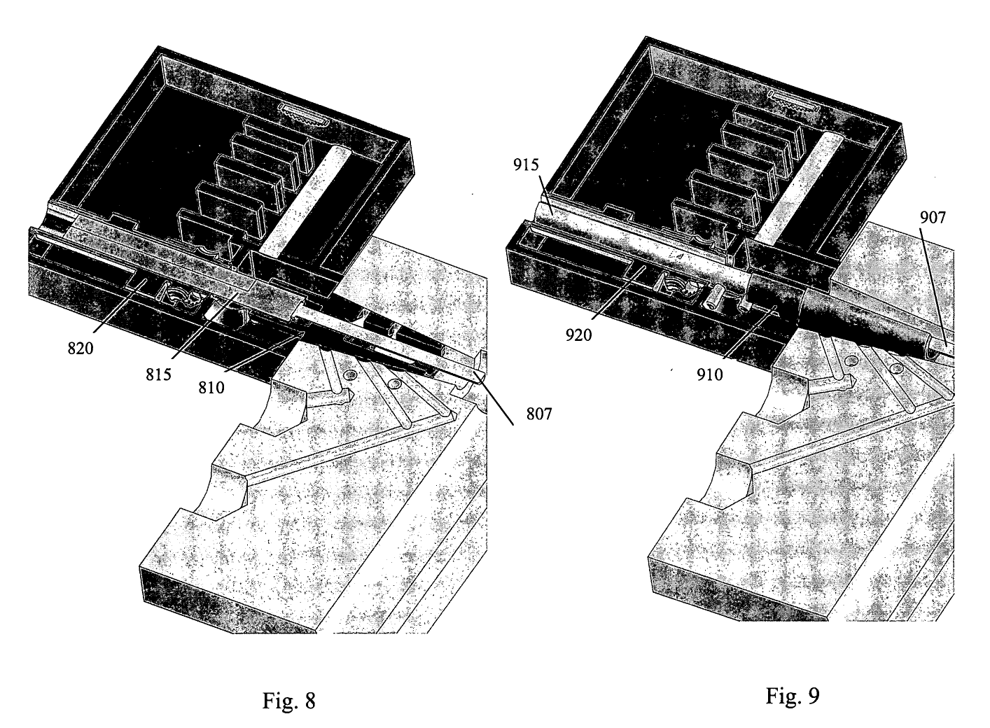

The storage configuration of the gas flow control system 370, when not in use, is characterised by the cam spindle 315 being fully pushed into the gas flow regulating valve 310, such that the push pin 307 pushes the safety valve spindle 303 into the fully open configuration of the safety valve 300. At the same time, the gas flow regulating valve 310 is rotated into the fully closed position. This configuration is shown in FIG. 8.

Most operations within the gas flow control system are effected by the processor 1070, upon receiving a request from the user. For example, upon request, the processor 1070 effects processes, such as connecting thermocouple S1 to, or disconnecting thermocouple S1 from, electromagnetic coil 301, as well as rotating various spindles in clockwise or anticlockwise direction.

In use, the system 370 operates in the following manner. The system is usually triggered by a user depressing a button (a knob or a switch) or touching a capacitance-based touch pad. The technology involved in such triggering can be any one of the following; capacitive, infrared or acoustic resonance. When the system is triggered, a driving signal is sent to a processor 1070, shown in FIG. 10. Upon receiving the trigger signal, the processor 1070 powers up the electromagnetic coil 301 by connecting the coil 301 to both thermocouple S1, shown in FIG. 10, and the rechargeable battery 1065. Since the plate 305 is already in a close proximity to the coil 301, the electromagnetic force generated by the powered electromagnetic coil 301 attracts plate 305 and locks the safety valve 300 into its fully open configuration. At the same time, a driving signal is sent from the microprocessor 1070 to the motor 321 for rotating the cam spindle 315 in a clockwise direction. Such rotation initially retracts the cam spindle 315 to release the pressure on the push pin 307. Further rotation in this direction then gradually opens the gas flows regulating valve 310 to allow an increased gas flow to the burner. Since the push pin 307 is released immediately after the first triggering signal, the safety valve spindle 303 is no longer pushed into the open configuration and the safety valve 300 is ready to perform its safety function. This configuration is shown in FIG. 9.

The processor 1070 is programmed so that the angle of rotation of the gas flow regulating valve 310 depends on the length of time for which a system start button, not shown, is depressed. Thus, depending on this time, the processor 1070 continuous to drive the cam spindle 315 until the gas flow regulating valve 310 reaches a predetermined angular position, or is fully opened. Immediately after the gas flow regulating valve 310 is opened, the processor 1070 drives the electronic ignition module, not shown, to generate a spark and ignite the supplied gas. A predetermined amount of time after the start button is depressed (or released) the processor 1070 disengages the electronic ignition module and the battery power supply to the electromagnetic coil. This event can also be triggered by the processor 1070, when the processor 1070 detects that adequate electrical supply is produced by the thermocouple S1. The electric current emitted by the thermocouple S1 is monitored by an electronic sensor which is also connected to the processor 1070. By the time the battery power supply is disengaged, the thermocouple S1 is fully operational and can reliably maintain the power supply to the electromagnetic coil 301.

The gas flow control system 370 is now in its operational mode. In this mode the user can control the gas flow by simply depressing a button, labelled for example with “+” or “−”, for increasing or decreasing the gas flow, respectively. Depressing the respective button triggers the processor 1070 to send a driving signal to the motor 321 that rotates the gas flow regulating valve 310 in a respective direction. A clockwise rotation increases the gas flow, while an anti-clockwise rotation of the gas flow regulating valve 310 decreases the gas flow supplied by the system 350. For more precise control of the gas flow, the system 370 comprises transducers 325 that monitor the exact angular position of the driving spindle 320 and send status signals to processor 1070. The transducers 325 can be arranged to stop the valve at various predetermined rotational positions (angles) that correspond to gas flow rates that are generally required by the consumer's traditional cooking requirements. The transducers can further be arranged to avoid rotational positions (angles) in which the gas flow rate to the burner can compromise the safe performance of the burner itself. Such rotational positions (angles) can, for example, be associated with gas flow rate insufficient to maintain proper flame setting. The transducers are based on Hall-effect, a micro-switch or any other sensing and/or control technology.

The gas supply to the burner is terminated by the user pressing a stop button, not shown, which sends a terminating trigger signal to the processor. Upon receiving this signal, the processor 1070 sends a driving signal to the motor 321, which effects the rotation of the cam spindle 315 in an anti-clockwise direction. During this rotation, the cam spindle 315 firstly rotates the gas flow regulating valve 310 into its fully closed configuration. Then, the cam spindle 315 slides within the gas flow regulating valve 310 to move the push pin 307 into a position where the push pin 307 maintains the safety valve spindle 303 into a fully open configuration. Thus, at the end of its operational cycle, the gas flow control system 370 is arranged so that the safety valve 300 is fully open and the gas flow regulating valve 310 is fully closed.

A sample operational sequence is represented in the following table.

| | Spindle rotational | |
|---|---|---|
| Time (sec) | position (degrees) | Operational Stages |
| | | Clockwise Rotation |
| 0″ | 0° | A cam spindle (315)_maintains the safety valve open, the |
| | | gas flow regulating valve 310 is fully closed. |
| 0″ | 0° | A “+”-marked touch control button is activated to send a |
| | | trigger signal to the processor 1070. |
| .1″ | 0° | The processor 1070 powers up the electromagnet coil 301 |
| | | by connecting the coil 301 to rechargeable battery 1065 |
| | | (12 Volts; ≦40 mAh) and a thermocouple S1. |
| .2″ | 0°-5° | The processor 1070 activates the dc motor, which rotates |
| | | the cam spindle. |
| .25″ | 5°-8° | The safety valve is held in the open position by the |
| | | powered magnetic coil 301. No gas flows through the gas |
| | | flow regulating valve 310. |
| .3″ | 10° | The cam spindle 315 deactivates the pressure on the safety |
| | | valve spindle 303. |
| .4″ | 0°-45° | The processor 1070 triggers the electronic ignition module |
| | | to generate spark for ignition; the gas flow regulating valve |
| | | 310 opens a gas flow to one or more burners, the gas is |
| | | ignited. |
| 2.5″ | 45°-210° | When the “+”-marked button is released, depending on the |
| | | length of time during which the touch control button is |
| | | depressed, the cam spindle 315 keeps on rotating until the |
| | | gas flow regulation valve 310 is turned to a respective |
| | | rotational angle. The particular rotational position defines |
| | | the gas flow and is, therefore, associated with the |
| | | corresponding temperature settings. This operation is |
| | | controlled by the processor which receives signal from the |
| | | transducer 325. The processor 1070 stops the spindle |
| | | either at a predetermined step position or at the next |
| | | position, depending on the position of the spindle when the |
| | | push button is released. |
| 2.5″ | 45°-210° | Operator can make fine flame adjustments by pressing the |
| | | two touch control switches marked “+” and “−”. The |
| | | choice of rotational direction and length of time, during |
| | | which the respective button is depressed, allows accurate |
| | | control of the gas flow. |
| 8″ | | The processor 1070 disengages the electronic ignition |
| | | module and the current from rechargeable battery to the |
| | | electromagnetic coil. If this function is performed |
| | | electronically, by sensing the electric current emitted by the |
| | | thermocouple“S1”, then the timing is directly related to the |
| | | signal emitted by the thermocouple. |
| | | Anti-clockwise Rotation |
| | 210°-10° | A “−”marked button turns the gas flow regulation valve 310 |
| | | in the opposite direction to progressively reduce the gas |
| | | flow trough the valve. |
| | 10°-0° | In this rotation range of the cam spindle 315, the gas flow |
| | | control valve is closed. The cam spindle 315 pushes the |
| | | push pin to fully open the safety valve 300. |

The foregoing describes only some embodiments of the present invention, and modifications and/or changes can be made thereto without departing from the scope and spirit of the invention, the embodiments being illustrative and not restrictive. For example, the overall arrangement of the gas flow control system 370 may easily be changed so that the non-operational configuration of the system 370 is characterised by a closed safety valve and a gas flow regulating valve/s that could be either open or closed. While details of such configurations have not been described here, they are considered to be within the knowledge and skill of a skilled addressee. In addition, the cam arrangement of cam 316 and a cam formation 617, as well as the sliding arrangement between sliding pin 718 and sliding slip 719, can have different shapes and forms. For example, a groove would be able to successfully perform the functionality of the slit 719.

It is clear from the above description that the proposed gas flow control system 370 offers a convenient and reliable way for controlling the gas flow of the gas supplied to a gas burner. The system 370 ensures that the safety valve can at all time perform its safety functions and allows a precise control of gas flow. A good control of the gas flow allows the user an accurate temperature control, which is often required in cooking. Calculations indicate that a rotational speed of the driving spindle of approximately 6 rotations per minute facilitates an efficient operation of the system. A backup power supply 1068 ensures a reliable operation of the thermocouples used in the operation of the safety valve in the event of power failure. In addition, after the burner flame has been set and the system is in its operational configuration, because no external power is provided to the electromagnetic coil of the safety valve, the power consumption of the system is minimal. Whilst the illustrated system has been mostly directed to a single gas burner, it is envisaged that similar arrangements are applicable for two and more burners.

In the context of this specification, the word “comprising” means “including principally but not necessarily solely” or “having” or “including”, and not “consisting only of”. Variations of the word “comprising”, such as “comprise” and “comprises” have correspondingly varied meanings.

### INDUSTRIAL APPLICABILITY

It is apparent from the above that the arrangements described are applicable to any gas system in which gas is supplied to a gas burner.

1. A gas flow control system for regulating the gas supply to a burner, the system being driven by a drive shaft rotatable by a motor, the system comprising;
a safety valve arranged to open and close a gas supply opening, the safety valve comprising;
a safety valve spindle movable between an open and a closed configuration of the safety valve, the safety valve spindle being biased into the closed configuration, a first end of the safety valve spindle comprising a locking metal plate and a second end of the safety valve spindle comprising a sealing member arranged to seal the gas supply opening in the closed configuration; and
an electromagnetic coil configured, when the electromagnetic coil is powered up and when the locking metal plate is presented within an operational range of the coil, to attract the locking plate and lock the safety valve spindle in the open configuration; and
driving means configured for engaging the second end of the safety valve spindle for moving the safety valve spindle from the closed to the open configuration, the driving means comprising;
a push pin disposed so that a first end of the push pin is engageable with the second end of the safety valve spindle, the pin being movable to push the safety valve spindle from the closed to the open configuration; and
converter means disposed intermediate the drive shaft and the second end of the push pin, the converter means being configured to facilitate the conversion of the rotational movement of the drive shaft into a linear movement of the push pin.

2. The gas flow control system of claim 1, the system further comprising a gas flow regulating valve, the gas flowing through the safety valve being directed to further flow through the gas flow regulating valve, the arrangement being such that that rotation of the gas flow regulating valve in a first predetermined direction increases, while a rotation of the gas flow regulating valve in a second direction, opposite to the first predetermined direction, decreases the amount of gas supplied to the burner.

3. The gas flow control system of claim 1, wherein the converter means comprise a first cam formation secured to a housing accommodating at least a portion of the driving means, the driving means further comprising;
a cam spindle engageable with the second end of the push pin and with the flow regulating valve, the cam spindle comprising a second cam formation and being configured such that, upon rotation of the cam spindle, the second cam formation engages the first cam formation so that the rotating cam spindle rotates the gas flow regulating valve and slides, within the gas flow regulating valve, to effect the linear movement of the push pin;
a driving spindle engaged with the cam spindle so as to rotate the cam spindle; and
a reduction gear assembly connected intermediate the driving shaft and the driving spindle so as to rotate the driving spindle with a reduced rotational speed with respect to that of the driving shaft.

4. The gas flow control system of claim 3, wherein the second cam formation is a cam pin arranged to engage with a camming profile of the first cam formation.

5. The gas flow control system of claim 3, wherein the cam spindle comprises a sliding pin configured to engage with a sliding groove of the gas flow regulating valve such that rotating of the cam spindle rotates the gas flow regulating valve.

6. The gas flow control system of claim 3, wherein the gas flow regulating valve comprises an axial opening arranged to receive the push pin, such as the safety valve, the push pin, the gas flow regulating valve, the cam spindle and the driving spindle are axially aligned.

7. The gas flow control system of claim 3 wherein a non-operational configuration of the system is characterized by the cam spindle being rotated to a position where;
the gas flow regulating valve is fully closed; and
the push pin is moved to push the safety valve in a fully open configuration.

8. The gas flow control system of claim 7, wherein;
rotation of the cam spindle in the first predetermined direction initially releases the pressure on the push pin, further rotation of the cam spindle progressively opens the gas flow regulating valve; and
rotation of the cam spindle in the second direction initially progressively closes the gas flow regulating valve, once the gas flow regulating valve is fully closed, further rotation of the cam spindle pushes the push pin to move the safety valve spindle into a fully open configuration.

9. The gas flow control system of claim 1, wherein the electromagnetic coil is at least partially powered by a thermocouple located in the burner such that an interruption to the burning process cools down the thermocouple and discontinues the power supply to the electromagnetic coil, allowing the bias to move the safety valve spindle into closed configuration and to interrupt the gas supply to the burner.

10. The gas flow control system of claim 9, the system further comprising an alternative power supply to the electromagnetic coil during a warm up time of the thermocouple.

11. The gas flow control system of claim 1, the system comprising at least one transducer for sensing the angular position of the driving spindle.

12. The gas flow control system of claim 11, wherein the transducer is based on a Hall-effect or micro-switch sensing/control technology.

13. The gas flow control system of claim 1, wherein the bias is provided by a coil spring.

14. The gas flow control system of claim 11, the system further comprising:
trigger means activated by a user to trigger at least one control function of the gas flow control system;
an electronic ignition module arranged to ignite gas supplied by the gas flow control system; and
a processor arranged for receiving control signals from the trigger means, status signal from the at least one transducer or signals from the thermocouple, sending driving signals to the motor and the ignition module and, at least temporarily, providing alternative power to the electromagnetic coil.

15. The gas flow control system of claim 14, wherein the trigger means comprises at least one of a knob, a switch, a push button or a touch pad and uses capacitive, infrared or acoustic resonance technologies.

16. The gas flow control system of claim 15, wherein the at least one control function activated by the trigger means comprise at least one of;
turning on/off a gas supply; and
increasing/decreasing the gas flow,
whilst the driving signals send by the processor are associated with at least one of;
switching the motor on/off;
turning driving shaft in a particular direction;
switching the alternative power supply to the electromagnetic coil on/off;
triggering the electronic ignition module;
connecting/disconnecting the thermocouple to the electromagnetic coil; and
connecting/disconnecting a backup power supply to the electromagnetic coil.

17. The gas flow control system of claim 1 wherein the motor is a DC motor.

18. The gas flow control system of claim 10, wherein the alternative power supply is a battery rated: 12 Volts; <4 OmAh.

19. The gas flow control system of claim 1, wherein a trigger signal triggers the immediate release of the push pin, resulting in the safety valve spindle being no longer pushed into the open configuration and the safety valve being ready to perform its safety function.

20. A method of controlling the amount of gas provided to a gas burner, by using the gas flow control system of claim 1, the method comprising the following steps;
when a start touch button is pressed by a user, a first trigger signal is sent to a processor;
upon receiving the first trigger signal, the processor supplies power to the electromagnetic coil by connecting the electromagnetic coil to both a thermocouple, for at least partially powering the electromagnetic coil, and an alternative power supply, the powered electromagnetic coil locking the safety valve spindle in the open configuration;
a driving signal is sent from the processor to the motor for rotating a cam spindle, engageable with the second end of the push pin and with a gas flow regulating valve, in a predetermined first direction, the rotation of the cam spindle in the first direction initially releasing pressure on the push pin and then opening the gas flow regulating valve to provide gas to the burner;
the processor drives an electronic ignition module to generate a spark for igniting the gas;
upon a release of the touch button by the user, a second trigger signal is sent to the processor,
depending on the length of time between the first and the second trigger signals, the processor continues to drive the cam spindle until the gas flow regulating valve reaches a predetermined rotational position, the predetermined rotational position defining the gas flow through the gas flow regulating valve; and
a predetermined time after the first or the second trigger signal, or when the processor detects adequate electrical supply from the thermocouple, the processor disengages the electronic ignition module and the alternative power supply to the electromagnetic coil.

21. The method of claim 20 wherein, for discontinuing the gas supply to the burner, the method further comprises the steps of;
a stop touch button pressed by the user sends a third trigger signal to the processor; and
upon receiving the third trigger signal, the processor sends driving signals to the motor to rotate the gas flow regulating valve in the second direction to close the gas flow regulating valve and push the push pin to move and maintain the safety valve spindle into a fully open configuration.

22. The method of claim 20 wherein the gas flow is increased or decreased by depressing respective touch buttons to rotate the gas flow regulating valve in the first predetermined direction or in the second direction, respectively.

23. The method of claim 20, wherein the motor is a DC motor and the alternative power supply is a battery.

24. A gas burning apparatus implementing the gas flow control system of claim 1.

25. (canceled)
